(19) United States
(12) Patent Application Publication
(10) Pub. No.: US 2024/0202182 A1
(43) Pub. Date: Jun. 20, 2024

(54) DATA REPLICATION IN ACTIVE-ACTIVE DATABASES

(71) Applicant: International Business Machines Corporation, Armonk, NY (US)

(72) Inventors: Guang Han Sui, Beijing (CN); Peng Hui Jiang, Beijing (CN); Fan Jing Meng, Beijing (CN); Mai Zeng, Beijing (CN); Jun Su, Beijing (CN); Jia Tian Zhong, Beijing (CN)

(21) Appl. No.: 18/065,722

(22) Filed: Dec. 14, 2022

(51) Int. Cl. G06F 16/23; G06F 16/27

(52) U.S. Cl. CPC G06F 16/2365; G06F 16/27

(57) ABSTRACT

A method of managing an active-active database system storing a first copy of data records at a first node a second copy of the data records at a second node includes receiving a first set of operations stored at the first node as a first set of local operations, a copy of the first set of operations transmitted to the second node and stored as a first set of remote operations, and receiving a second set of operations stored at the second node as a second set of local operations, a copy of the second set of operations transmitted to the first node and stored as a second set of remote operations. The method includes determining a comparison point by selecting an operation from each of the first set of operations and the second set of operations, and comparing the first copy of the data records to the second copy.

### BACKGROUND

The present invention generally relates to database replication, and more specifically, to data replication in an active-active databases having a source site and a target site.

Most modern-day database systems employ database replication to ensure that critical databases provide redundancy to protect against the loss of data and to maintain the accessibility of the database. Database replication is the frequent copying of data from one database on one computer or server to another database on another computer or server. Database replication ensures that the failure of the computer or server will not result in the loss of the data stored in the database or a loss of accessibility to the database. In order to ensure consistency, so-called consistency checks are periodically performed to ensure that the copies of data are consistent. As databases can be very large, techniques that reduce the amount of time needed to perform consistency checks are desirable.

### SUMMARY

Embodiments of the present invention are directed to a method of managing an active-active database system. The method includes accessing the database system by a processing device, the database system storing a collection of data records, where the database system stores a first copy of the data records at a first node, and a second copy of the data records at a second node. The method also includes receiving a first set of operations at the first node, the first set of operations stored at the first node as a first set of local operations, a copy of the first set of operations transmitted to the second node and stored as a first set of remote operations, and receiving a second set of operations at the second node, the second set of operations stored at the second node as a second set of local operations, a copy of the second set of operations transmitted to the first node and stored as a second set of remote operations. The method further includes determining a comparison point by selecting an operation from each of the first set of operations and the second set of operations, and comparing the first copy of the data records to the second copy of the data records. The comparing includes comparing values of data records of the first copy that are not changed by operations subsequent to the comparison point, to values of data records of the second copy that are not changed by operations subsequent to the comparison point, comparing old data values of data records of the first copy that are updated by one or more subsequent operations, to old data values of data records of the second copy that are updated by one or more subsequent operations, comparing operations occurring after the comparison point, and determining whether the first and second nodes are consistent based on the comparing.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts an embodiment of an active-active database system;

FIG. 3 depicts an embodiment of the active-active database system of FIG. 2, which includes a comparison module at each node of the database system;

FIG. 4 depicts a flow diagram of a method for managing a database system and comparing copies of a data collection stored by the database system (e.g., as part of a consistency check), according to one or more embodiments of the invention; and

FIG. 5 depicts a portion of the database system of FIG. 3 and illustrates a comparison point used in the method of FIG. 4, according to embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

On or more embodiments of the present invention as directed to devices, systems and methods for monitoring and/or comparing replicated databases. An embodiment of a method includes accessing an active-active database that includes multiple copies of a data collection stored by multiple nodes (e.g., servers or data centers), such as a first node and a second node. The first node receives a first sequence of operations and the second node receives a second sequence of operations.

The method includes negotiating a comparison point based on the sequences of operations, and performing a two-stage comparison of the copies to check for consistency. In an embodiment, the first stage includes comparing existing data records of each copy (i.e., values of the data records prior to execution of operations subsequent to the comparison point), and the second stage includes comparing the operations subsequent to the comparison point. In an embodiment, the subsequent operations of the second module are sent to the first module, and the first module manages the order of execution of the second node's subsequent operations, as well as the first node's subsequent operations.

One or more embodiments of the present invention are rooted in computing technology, and provide improvements to computing technology, particularly, replicated databases and active-active databases. For example, the embodiments provide for consistency checks that can be performed in less time than other consistency check techniques. In addition, the comparison may be performed directly on the database without the need to extract records, and the embodiments touch the database fewer times than other techniques.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

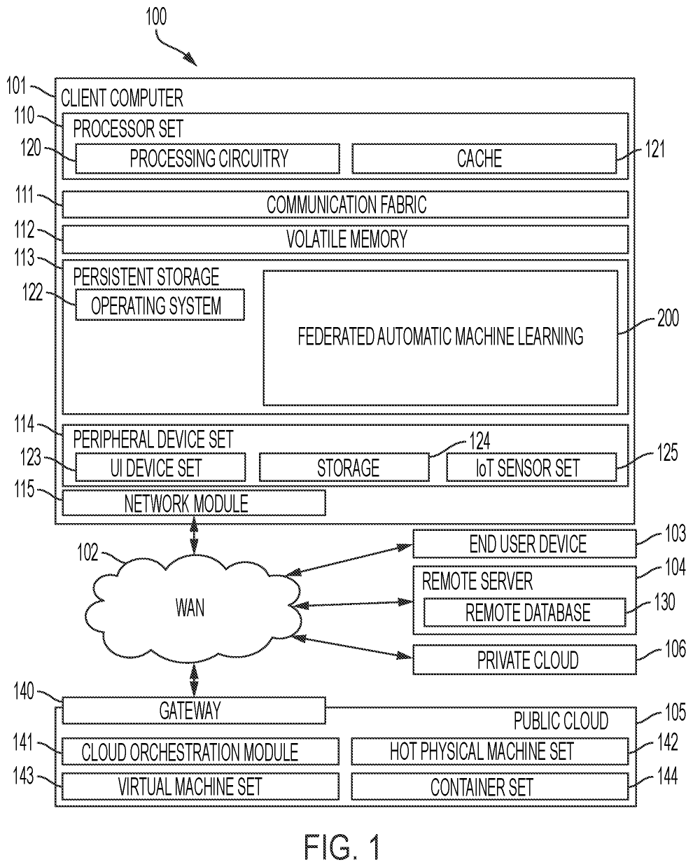

Referring now to FIG. 1, computing environment 100 contains an example of an environment for the execution of at least some of the computer code involved in performing the inventive methods, such as federated automatic machine learning 200 (referred to herein as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

In an embodiment, the computing environment 100 stores and/or manages a replicated database. Copies of the database may be stored at any suitable location. For example, one or more copies can be stored locally in the computer 101 and/or stored remotely (e.g., in the remote database 130).

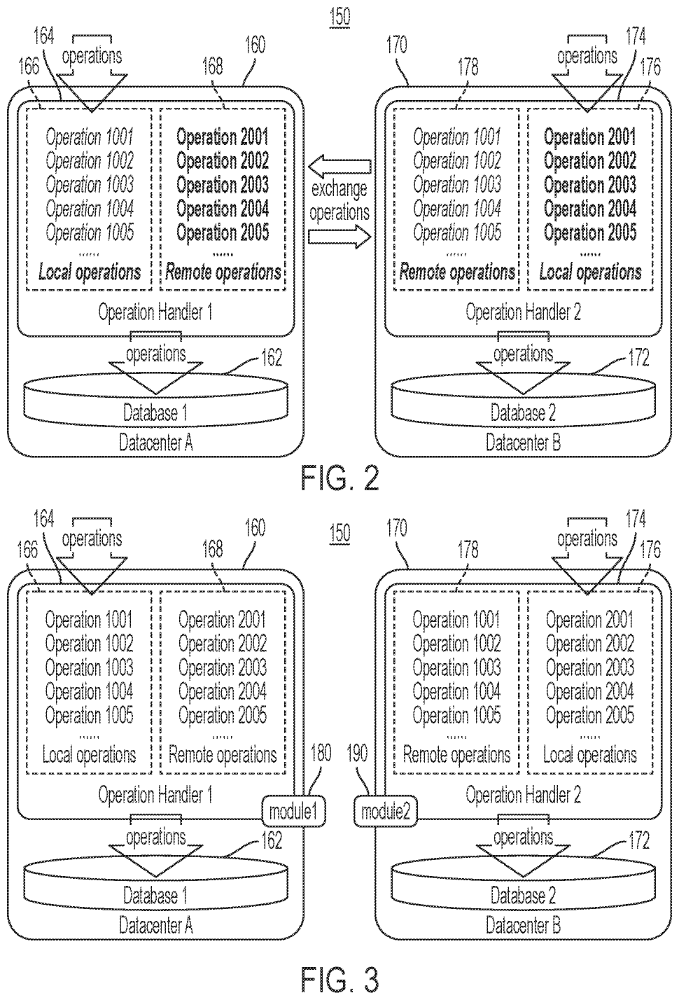

FIG. 2 depicts an embodiment of a database system 150 that stores a data collection including a plurality of data records. The database system 150 is replicated among a plurality of copies, where each database copy includes all of the data records stored in the database system 150. The copies provide redundancy to protect against the loss of data and to maintain the accessibility of the database system 150.

In an embodiment, the database system 150 is an active-active database. Redundant database systems are classified as either active-active or active-passive databases. Active-active databases architectures provide access to the resources of servers at both sites during normal operation. In contrast, in an active-passive database architecture, the servers at the backup site are only utilized during a failover condition. In active-active databases architectures, software data replication tools are utilized to ensure data consistency in both active sites.

For example, the database system 150 includes a first node 160 (e.g., a server, datacenter, etc.), and a second node 170. The first node 160 includes a storage (referred to as a first database 162) that stores a copy of the data collection. The second node 170 includes a storage (referred to as a second database 172) that stores a copy of the data collection. The database system 150 receives operations (e.g., reads and writes) from client devices and/or other locations.

As the database system 150 is utilized, various remote entities send requests for various operations to be performed, such as reads to the database, writes from the database, file creation and others. As operations are received and executed, both copies are updated to maintain consistency.

The operations are distributed among the nodes 160 and 170 (e.g., by a load balancer or other suitable device), such that some of the operations are transmitted to the first node 160 and applied to the database 162 by an operation handler 164. Other operations are transmitted to the second node 170 and applied to the database 172 by an operation handler 174.

For example, a first set of operations 166 (local operations) is received by the first node 160 and each operation therein is assigned a sequence number. A second set of operations 176 (local operations) is received by the second node 170, where each operation is assigned a sequence number. For example, the local operations 166 in the first node 160 are assigned sequence numbers i (e.g., 1001, 1002, 1003 . . . ), and the local operations 176 in the second node 170 are assigned sequence numbers j (e.g., 2001, 2002, 2003 . . . ). The sequence numbers specify the order in which each received operation is to be executed.

As noted above, each node maintains a copy of the collection of data, including all operations performed on data sets therein. For example, the first node 160 is synchronized with the second node 170 by exchanging copies of data and the received operations. As shown in FIG. 2, operations received by the first node 160 are exchanged by making a copy of the local operations 166 and transmitting the copy to the second node 170, which stores the copy as a set of remote operations 178. Likewise, a copy of the local operations 176 in the second node 170 is transmitted to the first node 160 and stored as a set of remote operations 168.

One or more processing devices are configured to perform consistency checks by periodically comparing the copy of the data collection in the first node 160 with the copy of the data collection in the second node 170. The one or more processing devices may be part of the nodes or otherwise located.

Referring to FIG. 3, an embodiment of the database system 150 includes a processing module (hardware, software or virtual) at each node for performing aspects of consistency checks by comparing the database copies as described herein. A first comparison module 180 is located at the first node 160 and a second comparison module 190 is located at the second node 170. The comparison modules 180 and 190 communicate with one another to facilitate comparing the copies of the database to ensure consistency. It is noted that, although two nodes and comparison modules are shown, the embodiments are not so limited and are applicable to systems having any number of nodes.

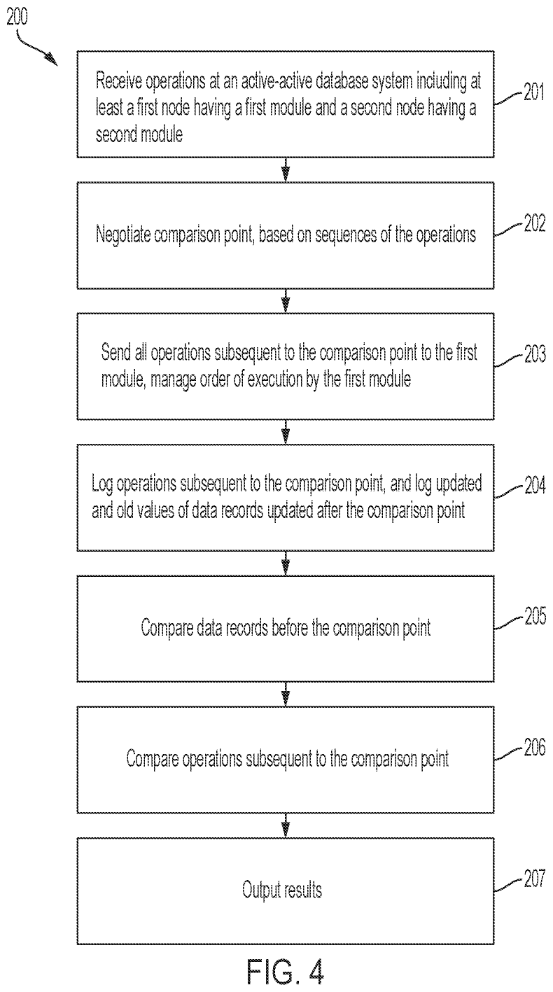

FIG. 4 depicts a flowchart of an embodiment of a method 200 of managing a database system and performing a consistency or otherwise comparing copies of a data collection stored therein. The method 200 includes a number of steps or stages represented by blocks 201-207. It is noted that the method may include all of the steps or stages or fewer than all of the steps or stages.

The method 200 may be performed by any suitable computing device or system. For example, the method can be performed by the computer 101, the processor set 110 and/or the end user device 103. The method 200 is described in conjunction with the database system 150 of FIG. 3 for illustration purposes.

At block 201, the database system 150 is accessed by one or more remote entities (e.g., client devices) and receives various requested operations. The operations are executed, and the copies of the database are updated as operations are executed to maintain consistency.

For example, the node 160 receives operations i and stores the received operations as a set of local operations 166 (e.g., from a load balancer), which are managed by the operation handler 164. Each operation i is assigned a sequence number (e.g., 1001, 1002 . . . ) that allows the operation handler 164 to execute the operations in a desired order. The node 170 receives operations j and stored the received operations as a set of local operations 176, which are assigned sequence numbers (e.g., 2001, 2002 . . . ). The nodes exchange copies of the sets of operations, so that the node 160 stores operations j as a set of remote operations 168, and the node 170 stores the operations i as a set of remote operations 178.

At block 202, the comparison modules 180 and 190 negotiate a comparison point, which is defined by selecting an unexecuted operation from the local operations 166, and selecting an unexecuted operation from the local operations 176. The comparison point divides each set of operations into previous operations and subsequent operations.

For example, the comparison module 180 determines an operation (e.g., operation 1003) that has not been executed, and is scheduled to be executed at a time far enough in the future so that the modules can prepare for an upcoming comparison. The module 180 selects an operation (e.g., operation 2003) from the local set of operations (i.e., operations managed by the node 170), and communicates with the comparison module 190.

The comparison module 190 determines whether the comparison can commence at the local operation (e.g., operation 1003) selected by the module 180. If so, the comparison module 190 provides a positive response to the communication, and the selected operations (1003 and 2003) represent the comparison point. If not, the module 190 responds negatively, and the module 180 selects another pair of operation from the local and remote sets and again communicates with the module 190. This process is repeated until a comparison point is agreed upon.

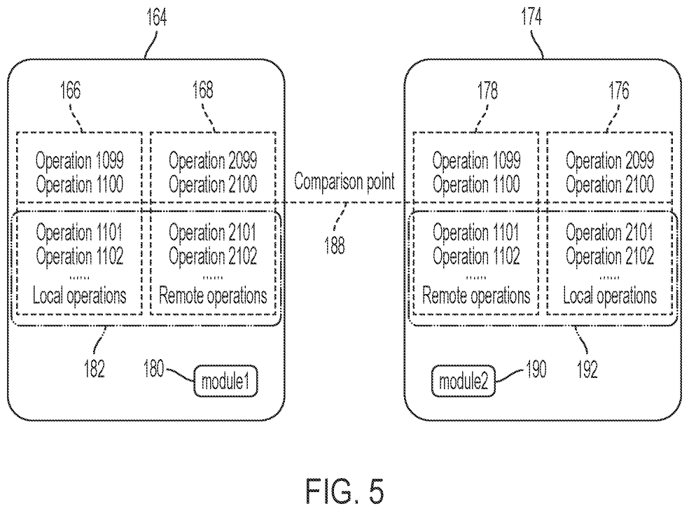

FIG. 5 shows an example of a comparison point. In this example, the negotiation resulted in operation 1100 (local to the node 160) and operation 2100 (local to the node 170). The comparison point (represented by line 188) is agreed upon, and the comparison will commence after operations before the comparison point 188 have completed. In the example of FIG. 5, operations 182 and operations 192 are the subsequent operations.

At block 203, to ensure the operation order in both databases is same, all of the operations (both operations sent to the node 160 and operations sent to the node 170) after the comparison point (e.g., operations 1101, 1102 . . . , and operations 2101, 2102, . . . ) are sent to the module 180. The module 180 will then manage both sets of subsequent operations (i.e., manage the order by which the operations are executed). This ensures that the operation order will be same for both nodes.

At block 204, the operations after the comparison point are logged by each module (i.e., copied to a separate comparison log or table). In addition, for data records that are updated by any of the subsequent operations, updated values of the data records are logged, as well as the values (“old values”) of these data records before updating. The logged data values may be used for the comparison discussed below, which reduces comparison time and allows the modules to touch the database fewer times.

In an embodiment, each record that is changed during the comparison is flagged. Such flags allow the modules to compare only changed values in the database records, to save time.

At block 205, a first comparison is performed, in which the data records before the comparison point are compared. In other words, the previous values of the data collection (i.e., values before execution of operations subsequent to the comparison point) stored by the first node 160 are compared to the previous values of the data collection stored by the second node 170.

The first comparison includes comparing values of data records of the first copy that are not changed by operations subsequent to the comparison point, to values of data records of the second copy that are not changed by operations subsequent to the comparison point. This comparison can be performed directly on database records without the need for extraction. In addition, old data values of the records logged from the first copy are compared to old data values of the records logged from the second copy.

At block 206, the operations subsequent to the comparison point are compared. For example, all of the subsequent operations 182 (local and remote) are compared sequentially (e.g., by sequence number) to all of the subsequent operations 192 (local and remote). As these operations are logged, the comparison logic is simple and clean (e.g., just ensure the count are same and order are same).

At block 207, results of the various comparisons are output. Such results may be output to a user, processor other entity or location. The results can be used to perform various actions, for example, if any of the comparisons are unsuccessful (i.e., the copies are not consistent), various actions can be performed to address inconsistencies. For example, if the copies of data records are inconsistent, the database records can be checked manually and then updated them to correct one. For an upcoming comparison, the records stored prior to this update can be re-used. In another example, if operations are inconsistent, the database logs can be checked for the operations, and the data record updated accordingly. In this example, the updated data records are used for an upcoming comparison (ignoring the old operations prior to the update).

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk drive (HDD), a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method of managing an active-active database system, the method comprising:
accessing the database system by a processing device, the database system storing a collection of data records, wherein the database system stores a first copy of the data records at a first node, and a second copy of the data records at a second node;
receiving a first set of operations at the first node, the first set of operations stored at the first node as a first set of local operations, a copy of the first set of operations transmitted to the second node and stored as a first set of remote operations;
receiving a second set of operations at the second node, the second set of operations stored at the second node as a second set of local operations, a copy of the second set of operations transmitted to the first node and stored as a second set of remote operations;
determining a comparison point by selecting an operation from each of the first set of operations and the second set of operations;
comparing the first copy of the data records to the second copy of the data records, wherein the comparing includes;
comparing values of data records of the first copy that are not changed by operations subsequent to the comparison point, to values of data records of the second copy that are not changed by operations subsequent to the comparison point;
comparing old data values of data records of the first copy that are updated by one or more subsequent operations, to old data values of data records of the second copy that are updated by one or more subsequent operations;
comparing operations occurring after the comparison point; and
determining whether the first and second nodes are consistent based on the comparing.

2. The method of claim 1, wherein the processing device includes a first comparison module stored locally with the first copy and a second comparison module stored locally with the second copy.

3. The method of claim 2, wherein the first comparison module negotiates with the second comparison module to select the comparison point based on a sequence of the first set of operations and a sequence of the second operations.

4. The method of claim 3, wherein the first module negotiates with the second module to provide sufficient time to prepare the first module and the second module to perform a comparison.

5. The method of claim 2, transmit all subsequent operations occurring after the selected operations from the second node to the first node, and manage the order of execution of each of the subsequent operations by the first module.

6. The method of claim 1, further comprising logging the old data values of data records of the first copy that are updated by the one or more subsequent operations, and logging the old data values of data records of the second copy that are updated by one or more subsequent operations.

7. The method of claim 1, further comprising adding a flag to each data record of the first copy and the second copy that is updated by the one or more subsequent operations.

8. The method of claim 1, wherein the first comparison and the second comparison are performed independently.

9. A system for managing an active-active database system, the system comprising:
a processor communicatively coupled to a memory, the processor configured to perform:
accessing the database system by a processing device, the database system storing a collection of data records, wherein the database system stores a first copy of the data records at a first node, and a second copy of the data records at a second node;
receiving a first set of operations at the first node, the first set of operations stored at the first node as a first set of local operations, a copy of the first set of operations transmitted to the second node and stored as a first set of remote operations;
receiving a second set of operations at the second node, the second set of operations stored at the second node as a second set of local operations, a copy of the second set of operations transmitted to the first node and stored as a second set of remote operations;
determining a comparison point by selecting an operation from each of the first set of operations and the second set of operations;
comparing the first copy of the data records to the second copy of the data records, wherein the comparing includes:
comparing values of data records of the first copy that are not changed by operations subsequent to the comparison point, to values of data records of the second copy that are not changed by operations subsequent to the comparison point;
comparing old data values of data records of the first copy that are updated by one or more subsequent operations, to old data values of data records of the second copy that are updated by one or more subsequent operations;
comparing operations occurring after the comparison point; and
determining whether the first and second nodes are consistent based on the comparing.

10. The system of claim 9, wherein the processing device includes a first comparison module stored locally with the first copy and a second comparison module stored locally with the second copy.

11. The system of claim 10, wherein the first comparison module negotiates with the second comparison module to select the comparison point based on a sequence of the first set of operations and a sequence of the second operations.

12. The system of claim 11, wherein the first module negotiates with the second module to provide sufficient time to prepare the first module and the second module to perform a comparison.

13. The system of claim 10, transmit all subsequent operations occurring after the selected operations from the second node to the first node, and manage the order of execution of each of the subsequent operations by the first module.

14. The system of claim 9, wherein the processing is configured to further perform:
logging the old data values of data records of the first copy that are updated by the one or more subsequent operations, and logging the old data values of data records of the second copy that are updated by one or more subsequent operations.

15. A computer program product for managing an active-active database, comprising a computer readable storage medium having program instructions embodied therewith, the program instructions executable by a processor to cause the processor to perform a method comprising:
accessing the database system by a processing device, the database system storing a collection of data records, wherein the database system stores a first copy of the data records at a first node, and a second copy of the data records at a second node;
receiving a first set of operations at the first node, the first set of operations stored at the first node as a first set of local operations, a copy of the first set of operations transmitted to the second node and stored as a first set of remote operations;
receiving a second set of operations at the second node, the second set of operations stored at the second node as a second set of local operations, a copy of the second set of operations transmitted to the first node and stored as a second set of remote operations;
determining a comparison point by selecting an operation from each of the first set of operations and the second set of operations;
comparing the first copy of the data records to the second copy of the data records, wherein the comparing includes:
comparing values of data records of the first copy that are not changed by operations subsequent to the comparison point, to values of data records of the second copy that are not changed by operations subsequent to the comparison point;
comparing old data values of data records of the first copy that are updated by one or more subsequent operations, to old data values of data records of the second copy that are updated by one or more subsequent operations;
comparing operations occurring after the comparison point; and
determining whether the first and second nodes are consistent based on the comparing.

16. The computer program product of claim 15, wherein the processing device includes a first comparison module stored locally with the first copy and a second comparison module stored locally with the second copy.

17. The computer program product of claim 16, wherein the first comparison module negotiates with the second comparison module to select the comparison point based on a sequence of the first set of operations and a sequence of the second operations.

18. The computer program product of claim 17, wherein the first module negotiates with the second module to provide sufficient time to prepare the first module and the second module to perform a comparison.

19. The computer program product of claim 16, transmit all subsequent operations occurring after the selected operations from the second node to the first node, and manage the order of execution of each of the subsequent operations by the first module.

20. The computer program product of claim 15, wherein the method further includes logging the old data values of data records of the first copy that are updated by the one or more subsequent operations, and logging the old data values of data records of the second copy that are updated by one or more subsequent operations.
